(19) United States
(12) Patent Application Publication
(10) Pub. No.: US 2009/0161501 A1
(43) Pub. Date: Jun. 25, 2009

(54) FOCUS CONTROL METHOD AND OPTICAL DISC APPARATUS

(75) Inventors: Hiroshi Kubota, Fussa-shi (JP); Yoshinori Tazaki, Yokohama-shi (JP); Kazumi Sugiyama, Kawasaki-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/255,151

(22) Filed: Oct. 21, 2008

(30) Foreign Application Priority Data
Dec. 25, 2007 (JP) 2007-333305

(51) Int. Cl. G11B 7/00

(52) U.S. Cl. 369/44.13; 369/44.32; G9B/7

(57) ABSTRACT

According to one embodiment, when a focus servo goes off and the distance between an objective lens and a recording layer of an optical disc does not coincide with a focal length of the objective lens, a control voltage or current corresponding to an optical disc wobble stored in a memory is superimposed on a control voltage or current supplied to a driving mechanism to move an objective lens along an optical axis for re-focusing, and the superimposed voltage or current is supplied to the driving mechanism. Therefore, pull-in of a focus servo for re-focusing is possible in a short time.

### CROSS-REFERENCE TO RELATED APPLICATIONS

This application is based upon and claims the benefit of priority from Japanese Patent Application No. 2007-333305, filed Dec. 25, 2007, the entire contents of which are incorporated herein by reference.

### BACKGROUND

1. Field

One embodiment of the invention relates to a focus control method capable of preventing unstable pull-in of a focus servo caused by wobble of an optical disc as a recording medium, or judgment as a disc error, and an optical disc apparatus employing the focus control method.

2. Description of the Related Art

A long time has been past since the practical use of an optical disc apparatus, or an apparatus to use a laser beam to record and reproduce information on/from an optical disc.

An optical disc of a Digital Versatile Disc (DVD) standard has been widely used as a recording medium (an optical disc). An optical disc of a High-Definition (HD) DVD standard has been developed from a DVD standard optical disc and practically used for high density recording.

Most optical discs, not limited to HD DVD and DVD standard discs, are formed as circular discs with a recording layer and a reflection layer stacked on a resin base. Thus, when a disc is rotated about an axis orthogonal to the disc surface (in the spreading direction) as the center of rotation, oscillation called wobble is generated along the axis of rotation, or vibration is generated according to a rotational cycle.

The wobble can be restricted, but cannot be reduced to zero. Therefore, various techniques have been proposed for reducing the influence of wobble included in a reproduction signal from an optical disc, or eliminating a component caused by wobble from a reproduction signal.

For example, Japanese Patent Application Publication (KOKAI) No. 2005-50410 discloses a technique to store a periodically generated disturbance light accompanying with rotation of a disc, in a memory.

For example, Japanese Patent Application Publication (KOKAI) No. Hei9-80298 discloses a technique to add a lens driving current supplied to a control system of an objective lens for controlling the distance between an optical disc and an objective lens to be constant, to a feedback control system for rotation of an optical disc.

However, in both of the above disclosed techniques, when an optical disc capable of recording at a high double speed is rotated at a recording speed higher than a predetermined speed (at a speed higher than an n times (n is a positive real number) speed), movement of an objective lens (an actuator) for pulling in a focus servo does not follow wobble of an optical disc, and the optical disc rotational speed must be decreased.

Therefore, the time required to complete pull-in of the focus servo is increased.

### BRIEF DESCRIPTION OF THE SEVERAL VIEWS OF THE DRAWINGS

A general architecture that implements the various feature of the invention will now be described with reference to the real number drawings. The drawings and the associated descriptions are provided to illustrate embodiments of the invention and not to limit the scope of the invention.

FIG. 1 is an exemplary diagram showing an example of an optical disc apparatus according to an embodiment of the invention;

FIG. 2A is an exemplary diagram showing an example of the relationship between an output signal from a photodetector of an optical head unit (ACT) used in the optical disc apparatus shown in FIG. 1 and the intensity of a reflected light from a recording layer of an optical disc;

FIG. 2B is an exemplary diagram showing an example of the relationship between an output signal from a photodetector of an optical head unit (ACT) used in the optical disc apparatus shown in FIG. 1 and a driving current applied to the ACT for moving an objective lens;

FIG. 2C is an exemplary diagram showing an example of the relationship between an output signal from a photodetector of an optical head unit (ACT) used in the optical disc apparatus shown in FIG. 1, a position of an objective lens, and completion of pull-in of a focus servo (on/off of a focus servo);

FIG. 3 is an exemplary diagram showing an example of the relationship between the focus driving voltage shown in FIG. 2B and wobble of an optical disc of the optical disc apparatus shown in FIG. 1;

FIGS. 4A and 4B are exemplary diagrams showing an example of decreasing the acceleration applied to an ACT by reflecting the detected wobble of an optical disc shown in FIG. 3, on the movement of an ACT;

FIG. 5 is a flowchart showing an example of a method of extracting the wobble of an optical disc for reflecting on the movement of an ACT shown in FIGS. 4A and 4B; and

FIG. 6 is a flowchart showing an example of a method of reflecting the wobble of an optical disc extracted for reflecting on the movement of an ACT shown in FIGS. 4A and 4B.

### DETAILED DESCRIPTION

Various embodiments according to the invention will be described hereinafter with reference to the accompanying drawings. In general, according to one embodiment of the invention, when a focus servo goes off and the distance between an objective lens and a recording layer of an optical disc does not coincide with a focal length of the objective lens, a control voltage or current corresponding to an optical disc wobble stored in a memory is superimposed on a control voltage or current supplied to a driving mechanism to move an objective lens along an optical axis for re-focusing, and the superimposed voltage or current is supplied to the driving mechanism.

Embodiments of this invention will be described in detail with reference to the drawings.

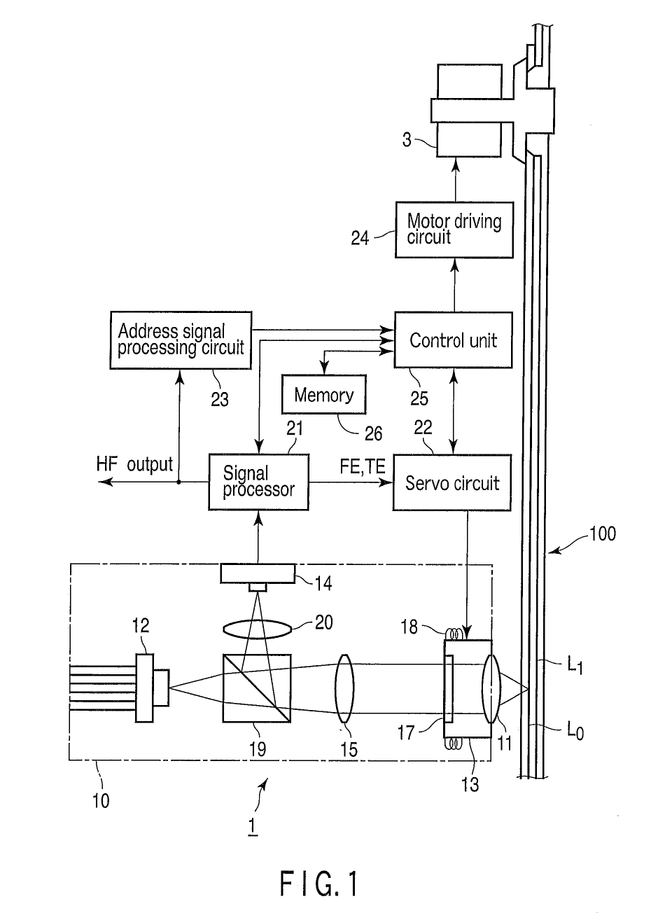

FIG. 1 shows an example of the configuration of an information recording/reproducing apparatus (an optical disc apparatus) according to an embodiment of the invention.

An optical disc apparatus 1 shown in FIG. 1 includes an optical pickup unit (an optical head unit) 10, which can record information on a recording layer (not described in detail) of a recording medium (an optical disc) 100, for example, an organic film, metallic film or a phase-change film, or read information recorded on a recording layer, or erase information recorded on a recording layer. The optical disc apparatus 1 also includes mechanical elements, such as a disc motor 3 to rotate the optical disc 100 at a predetermined speed, and a not-shown head moving mechanism to move the optical head unit 10 along a recording surface of an optical disc D, in addition to the optical head unit 10. The optical disc unit 1 includes a signal processor 21 to process the output of a photodetector incorporated in the optical head unit 10, and a controller to control the mechanical elements of the optical head unit 10, as explained later.

The optical head unit 10 includes an objective lens 11 located in proximity to the optical disc 100, which condenses a laser beam from a laser diode (LD) 12 that is a semiconductor laser element, for example, on a desired recording layer L0 or L1 of the optical disc 100, and captures a laser beam reflected on a recording layer of the optical disc 100. The wavelength of the laser beam output from the laser diode 12 is 400 to 410 nm, for example, preferably 405 nm. The laser diode (LD) 12 may be of a combination type capable of outputting light with two or more wavelengths. In such a case, a laser beam with a wavelength of 650 to 680 or 770 to 800 nm will be output.

The objective lens 11 is movable in a focusing direction or a tracking direction as described later, when it is held by an actuator (hereinafter, called an ACT). The objective lens is also movable along the optical axis of the objective lens 11, following wobble of the optical disc 100. The numerical aperture (NA) of the objective lens 11 is 0.65, for example.

A laser beam from the laser diode 12 passes through a polarized beam splitter (PBS) 19 provided at a predetermined position, and is collimated (paralleled) by a collimator lens (CL) 15, and is guided to the objective lens (OL) 11 through a diffraction element 17, in which an optical splitter or a hologram plate (a hologram optical element (HOE)) is formed as one piece with a λ/4 plate (¼ wavelength plate, or a polarization control element). The objective lens 11 and diffraction element 17 are held as one piece by the actuator 13.

The laser beam guided to the objective lens 11 is given a predetermined convergence by the objective lens 11, and then condensed on one of the recording layers L0 and L1 of the optical disc 100. Each of the recording layers L0 and L1 of the optical disc 100 has a concentric or spiral guide groove that is a record track, or a record mark string (recorded data) with a 0.34- to 1.6-μm pitch.

The laser beam given a predetermined convergence by the objective lens 11 passes through a cover layer (not described in detail) of an optical disc, and condensed on (or in proximity to) any one of the recording layers. (The laser beam from the LD 12 provides a minimum optical spot at a focal position of the objective lens 11.)

The objective lens 11 is located at a predetermined position in the tracking direction crossing a track (a record mark string) on each recording layer of the optical disc 100, and at a predetermined position in the focusing direction that is a thickness direction of the recording layer, by a not-shown objective lens driving mechanism including a driving coil and a magnet, for example. Position control of the objective lens 11 for making a minimum optical spot of a laser beam coincide with the center of a track (a record mark string) by moving the objective lens 11 in the tracking direction is called a tracking control. Position control of the objective lens 11 for making the distance between the recording layer and the objective lens 11 coincide with the focal length of the objective lens 11 by moving the objective lens 11 in the focusing direction is called a focus control.

The laser beam reflected on a desired recording layer L0 or L1 of the optical disc 100 is captured by the objective lens 11, converted into a beam with an almost parallel sectional shape, and returned to the diffraction element 17.

As the diffraction element 17 functions also as a λ/4 plate, the reflected laser beam returned to the diffraction element 17 and returned to a polarization beam splitter 19 is reflected on a polarization plane (not described in detail) of the polarization beam splitter, because its polarizing direction is turned 90° from the polarizing direction of a laser beam directed to a recording layer of the optical disc 100.

The reflected laser beam from the polarization beam splitter 19 is given an astigmatic aberration by a cylindrical lens 20 having a power inclined 45° to a tangential or radial direction, and is then given a predetermined convergence by the collimator lens 15, and is imaged on the light-receiving surface of the photodetector (PD) 14. At this time, when passing through the diffraction element 17, the reflected laser beam is diffracted into a predetermined number of splits and shapes according to the arrangement and shape of a detection area (a light-receiving area) given previously to the light-receiving surface of the photodetector 14.

The current output from each light-receiving part of the photodetector 14 is converted to a voltage by a not-shown I/V amplifier (a current-voltage converter), and processed by the signal processor 21 to be usable as a HF (reproduction) output, a tracking error signal TE, a focus error signal FE, or a cancel signal to prevent the objective lens 11 from becoming out of focus by the influence of wobble of an optical disc. The HF (reproduction) output is converted into a predetermined signal format, or output to a temporary storage or an external storage through a predetermined interface (not described in detail). Among the information recorded in the optical disc 100 read by reproducing the HF (reproduction) output, the header information (physical address reproduction signal), for example, is sent to an address signal processing circuit 23, in which the address information or the information indicating the track or sector of the optical disc 100 that is now opposed to the objective lens 11 of the optical head unit 11 is taken out, and supplied to a motor driving circuit 24. Therefore, the speed of rotating the optical disc 100, that is, the number of driving pulses to be supplied to the disk motor 3 is determined. The signal processor 21, servo circuit 22 and motor driving circuit 24 are controlled by a control unit 25. The control unit 25 is connected to a memory 26 that stores a periodic signal (the amount of wobble) related to the wobble of the optical disc 100, as explained later.

The signal obtained by the signal processor 21 is used as a servo signal for moving the objective lens 11 in the tracking direction (the optical axis direction) orthogonal to the surface including the recording surface of the optical disc 100, and in the direction orthogonal to the direction of extending the track or record mark (string) formed previously on the recording surface of the optical disc, through the servo circuit 22, so that the distance from the objective lens 11 to the recording layer L0 or L1 on the recording surface of the optical disc coincides with the focal length of the objective lens 11. As described later, a servo mechanism (e.g., a coil and a fixed magnet) 18 of the ACT 13 is supplied with a signal for canceling the influence of the wobble of the optical disc 100, together with (superimposed on) a focus error signal that is used to make the distance between the objective lens 11 and optical disc 100 coincide with the focal length of the objective lens 11.

A servo signal is generated based on a focus error signal to indicate a change in the position of the objective lens 11 according to a known focus error detection method, so that an optical spot having a predetermined size at a focal position of the objective lens 11 becomes the same predetermined size on the recording layer L0 or L1 of the optical disc 100, and a tracking error signal to indicate a change in the position of the objective lens 11 according to a known tracking error detection method, so that the optical spot is guided to almost the center of a track or a record mark string.

Namely, the objective lens 11 is moved in a predetermined direction by the servo mechanism 18 provided in the ACT 13 by using a servo signal supplied from the servo circuit 22, so that an optical spot condensed by the objective lens 11 is guided to almost the center of a track formed on the recording layer L0 or L1 of the optical disc 100, or a record mark string that is prerecorded information, as a minimum optical spot on the recording layer at that focal distance.

In the optical disc 100, two or more recordable times (the maximum recording time of the previously recorded information) can be set depending on the rate or the degree of compression of the recorded information. At the time of recording or reproducing, it is also possible to collectively record or reproduce certain time data (information) in the time shorter than the time (length) of actual video and audio. For example, in reproduction, even in high-speed reproduction called xn, i.e., an n times (where n is a positive real number) speed reproduction, a speed of rotating the optical disc 100 is set faster than the time of actual video and audio, according to a linear velocity when the optical head apparatus 10 traces the record mark string.

In the above background, it is known that the objective lens 11 (ACT 13) of the optical head unit 10 cannot follow wobble of an optical disc, when the wobble of the optical disc 100 exceeds a predetermined level due to the coplanarity of the optical disc 100 itself, or the influence of defective catching between the optical disc 100 and the disc motor 3 rotating the optical disc 100.

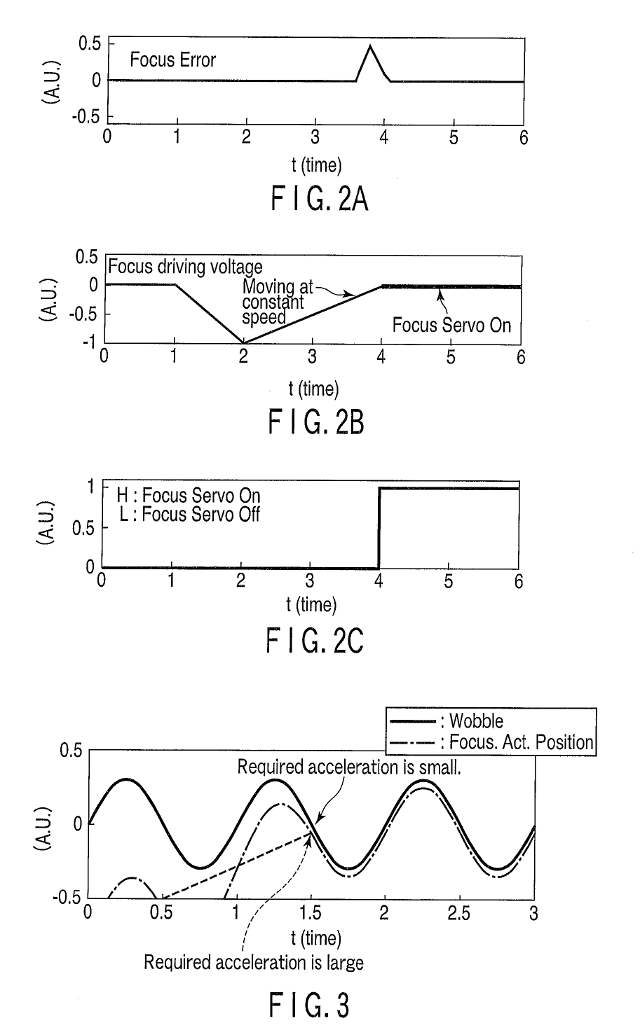

FIGS. 2A to 2C show the relationship between an output signal from a photodetector of an optical head unit (ACT) of the optical disc apparatus shown in FIG. 1 and the intensity of a reflected light from a recording layer of an optical disc, the relationship between an output signal from a photodetector of an optical head unit (ACT) of the optical disc apparatus shown in FIG. 1 and a driving current applied to the ACT for moving an objective lens, and the relationship between an output signal from a photodetector of an optical head unit (ACT) of the optical disc apparatus shown in FIG. 1, a position of an objective lens, and completion of pull-in of a focus servo (OFF to ON of a focus servo), respectively.

As shown in FIG. 2A, when the objective lens 11 (actually, the ACT 13) is moved from an initial position to the optical disc 100 at an equal speed by the drive current shown in FIG. 2, a focus error signal is detected at the time when the objective lens 11 is moved close to the recording layer of the optical disc 100. As the distance from the objective lens 11 to the optical disc 100 is unknown, the initial position of the objective lens 11 (ACT 13) is usually gradually moved from a position where the optical disc 100 does not exists (apart sufficiently from the optical disc 100) to a direction coming close to the optical disc 100. Therefore, as shown in FIG. 2A, when the objective lens 11 is moved farther, a focus error signal suddenly rises. When a focus error signal (FE) is detected, a focus control signal is generated according to an ordinary routine, and a focus servo is turned on (a focus servo is completely pulled in) at the timing shown in FIG. 2C.

FIG. 3 shows the relationship between the focus driving voltage shown in FIG. 2B and wobble of an optical disc.

The optical disc 100 is formed as a circular disc with a recording layer and a reflection layer stacked on a resin base. Therefore, wobble is usually synchronized with rotation of the disc 100. In contrast, the objective lens 11 (ACT 13) is moved toward the optical disc 100 with a certain increase ratio, as indicated by a broken line in the drawing. Thus, when the movement of the ACT 13 is made to follow the wobble of the optical disc 100, the acceleration acting on the ACT 13 may be reversed in the polarity.

This requires a sudden movement of the ACT 13, and the ACT 13 (the amount of displacement provided by the servo mechanism 18) cannot follow the requirement, and the time required to complete a focus servo is increased.

For example, in reproduction, when a focus servo (focus) goes off for some reason during high-speed reproduction called xn, i.e. n times (where n is a positive real number) speed reproduction, the ACT 13 (objective lens 11) cannot follow the wobble of the optical disc 100, because the optical disc 100 is rotated at high speed. Therefore, it is necessary to lower the linear velocity of the record mark string of the optical disc 100, that is, the rotational speed of the disc motor 3 to an initial value or a predetermined speed to enable pull-in of the focus servo, by the time the focus servo of the ACT 13 is completed.

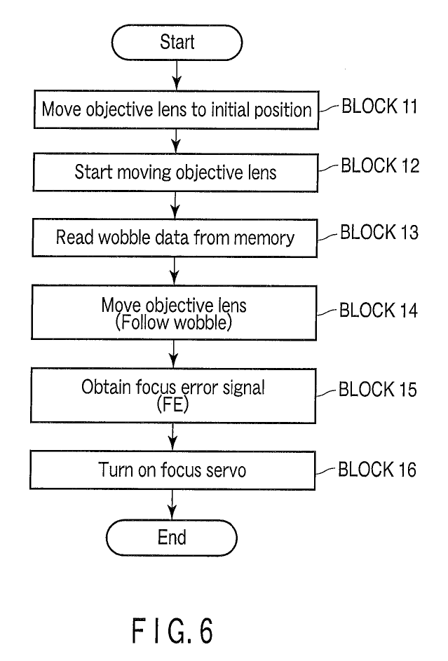

FIG. 5 and FIG. 6 show an example of the control to enable pull-in (re-focusing) of the focus servo in a short time, without decreasing the disc motor speed, when the focus servo goes off while the optical disc is rotating at high speed.

As shown in FIG. 5, the pull-in of the focus servo is completed as an ordinary operation, and the focus is held on (BLOCK 1).

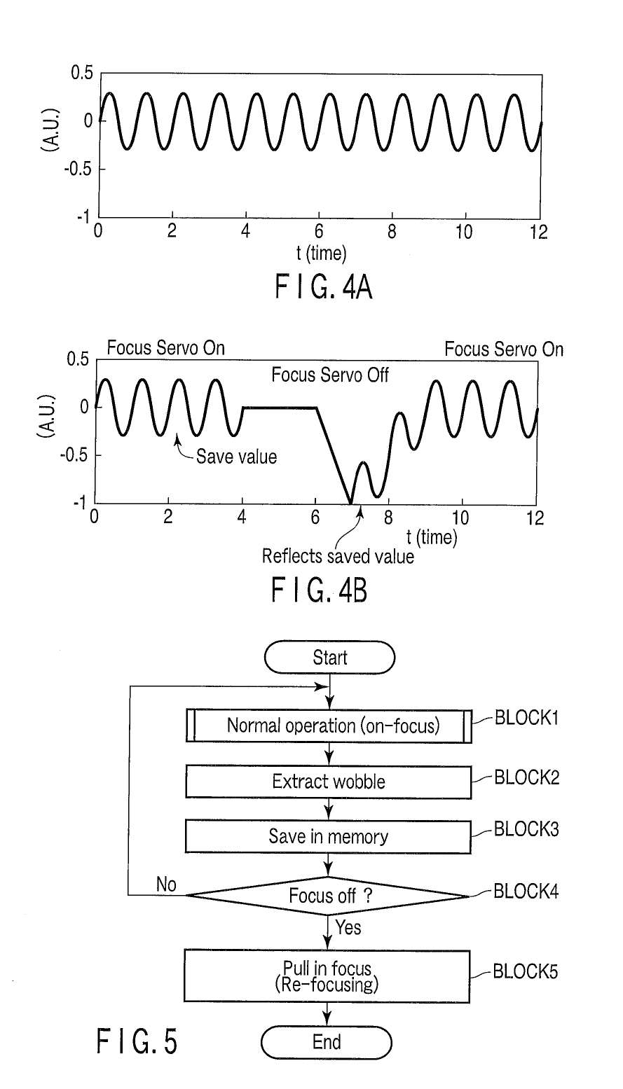

Next, while the focus is held on, wobble is extracted at the innermost radius of the optical disc 100 (BLOCK 2), for example, and is stored in the memory 26 (refer to FIG. 1). As shown in FIG. 4(a), the wobble can be caught as a certain amplitude oscillation at every rotational cycle of the optical disc 100. The data stored in the memory 26 is a low frequency range component of the driving current (or the driving voltage) supplied to the focus coil of the servo mechanism 18 incorporated in the ACT 13 as one piece, that is, a component except a frequency component much higher than the rotational speed of the disc motor 3 (BLOCK 3).

Thereafter, re-focusing (pull-in of the focus servo) is necessary, when a focus servo goes off (Yes in BLOCK 4) for some reason, for example, when the laser output is turned off for a certain time caused by an externally applied large shock, or when the laser output is turned off for a certain time for cooling the laser element (LD) 12 in the course of continuous recording, or when calibration becomes necessary owing to a temperature drift in the output of the photodetector 14. This is the same in the “standby” state in which neither seeking and accessing is executed for a certain time (BLOCK 5).

Refocusing (pull-in of the focus servo) is realized by moving the objective lens 11 (ACT 10) to the initial position or a predetermined position at which the focus servo pull-in routine is possible (BLOCK 11) as shown in FIG. 6, reading the amount of wobble of the optical disc 100 from the memory 26 (refer to FIG. 1) (BLOCK 13) while the objective lens (ACT 13) is being moved to the optical disc 100 at a constant speed (BLOCK 12) as shown in FIG. 2(b), and superimposing the read amount data on the driving signal supplied to the ACT 13 in BLOCK 12 (BLOCK 14).

Namely, the amount of wobble read from the memory 26 in BLOCK 13 of FIG. 6 is the amount of wobble extracted in BLOCK 2 and stored in the memory 26 in BLOCK 3 of FIG. 5, that is, the amount of wobble of the optical disc set now in the disc motor 3 and rotated. Therefore, as shown in FIG. 4B, by superimposing the amount of wobble during the pull-in of the focus servo of the ACT 13 (objective lens 11), the acceleration acting on the ACT 13 is prevented from reaching a level requiring such a large displacement as to reverse the polarity, as shown in FIG. 3.

Subsequent steps, generation of a focus error signal (FE) and pull-in of a focus servo are ordinary routines shown in FIGS. 2A to 2C, and detailed explanation on these steps will be omitted.

Therefore, even if the rotational speed of the optical disc 100 is high, or the disc motor 3 is rotated at high speed, re-focusing is possible in a short time by extracting the amount of wobble of an optical disc, while the ACT 13 (objective lens 11) is being held in-focus for the rotated optical disc 100, storing the read amount data in a memory, and superimposing the wobble component (especially, the low frequency component) saved in the memory on the ACT driving signal (the focus control signal) to move the ACT 13, for pulling in the focus servo (re-focusing) when the focus servo goes off for some reason, or for pulling in the focus servo (re-focusing) as actuating (accessing) from the state in which the laser beam output from a laser element is turned off in a standby state for power saving.

The extraction of wobble in step 2 of FIG. 5 may be performed at several positions in the radius of the optical disc 100, for example, every 10 or 20 mm. The amount (data) of wobble extracted at an arbitrary position in the radius of the disc is not shown, but is store in the memory 26 as a table (lookup table [LUT].)

Therefore, when the focus servo goes off, pull-in of the focus serve (re-focusing) can be realized in a shorter time by using the wobble data close to a corresponding zone or a radial position.

As is apparent from the above explanation, by using an embodiment of the invention, when a focus servo goes off during the focus servo and the distance between an objective lens and a recording layer of an optical disc does not coincide with a focal length of the objective lens, a control voltage or current corresponding to the wobble of the optical disc stored in a memory is superimposed on a control voltage or current supplied to a driving mechanism to move the objective lens along the optical axis for re-focusing. Therefore, when the focus servo goes off, re-pulling (re-focusing) of the focus serve is realized in a short time.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An optical disc device comprising:
a motor to rotate a recording medium at a predetermined speed;
a lens which condenses light from a light source on a recording layer of a recording medium, and captures light reflected on a recording layer of a recording medium;
a supporter which supports the lens movable along an optical axis of the lens, and in a direction crossing a track or a record mark string of a recording medium;
a photodetector which detects a reflected light captured by the lens, and outputs a predetermined output signal;
a memory which stores the result of extracting the degree of change in the distance of a recording medium to an optical axis of the lens, from an output of the photodetector, depending on a rotational cycle of the motor; and
a control unit which controls a position of the supporter by reflecting the result of extracting the degree of change in the distance of a recording medium to an optical axis of the lens depending on a rotational cycle of the motor stored in the memory, for moving again the supporter toward a recording medium, when the supporter falls in a state in which the distance between the lens and a recording layer of a recording medium does not coincide with a focal length of the lens, while the support is being moved to make the distance between the lens and a recording layer of a recording medium coincide with a focal length of the lens.

2. The optical disc apparatus according to claim 1, wherein the control unit superimposes a control amount corresponding to the result of extracting the degree of change in the distance of a recording medium to an optical axis of the lens depending on a rotational cycle of the motor stored in the memory, on a control amount supplied to a servo mechanism which moves the supporter to a recording layer of a recording medium at a constant speed, to make the distance between the lens and a recording layer of a recording medium coincide with a focal length of the lens.

3. The optical disc apparatus according to claim 1, wherein the degree of change in the distance of a recording medium to an optical axis of the lens depending on a rotational cycle of the motor is extracted at two or more positions in a direction crossing a track or a record mark string of a recording medium.

4. The optical disc apparatus according to claim 3, wherein the control unit superimposes a control amount corresponding to the result of extracting the degree of change in the distance of a recording medium to an optical axis of the lens depending on a rotational cycle of the motor held in the memory, on a control amount supplied to a servo mechanism which moves the supporter to a recording layer of a recording medium at a constant speed, to make the distance between the lens and a recording layer of a recording medium coincide with a focal length of the lens.

5. An optical disc apparatus comprising:
a motor to rotate a circular recording medium at a predetermined speed;
a lens which condenses light from a light source on a recording layer of a recording medium, and captures light reflected on a recording layer of a recording medium;
a supporter which supports the lens movable along an optical axis of the lens, and in a direction crossing a track formed on a recording medium, or a record mark string previously recorded on a recording medium;
a driving mechanism which generates a thrust to move the supporter along an optical axis of the lens, and in a direction crossing a track formed on a recording medium, or a record mark string previously recorded on a recording medium;
a photodetector which detects a reflected light captured by the lens, and outputs a predetermined output signal;
a memory which stores the result of extracting the degree of change in the distance of a recording medium to an optical axis of the lens, from an output of the photodetector, depending on a rotational cycle of the motor; and
a control unit which moves the supporter by setting a control amount supplied to the driving mechanism to an initial value or a control value for restart when a focus servo goes off and the distance between the lens and a recording layer of a recording medium does not coincide with a focal length of the lens during the focus servo for on the driving mechanism by supplying a predetermined control amount, to make the distance between the lens and a recording layer of a recording medium coincide with a focal distance of the lens, and controls a position of the supporter by superimposing a control amount corresponding to the result of extracting wobble stored in the memory, on the control amount supplied to the driving mechanism.

6. The optical disc apparatus according to claim 5, wherein the change of the distance of a recording medium and the lens along the optical axis of the lens depending on a rotational cycle of the motor is extracted at two or more positions in a direction crossing a track or a record mark string of a recording medium.

7. The optical disc apparatus according to claim 5, wherein the change of the distance of a recording medium and the lens along the optical axis of the lens depending on a rotational cycle of the motor is extracted during focus servo, to make the distance between the lens and a recording layer of a recording medium coincide with a focal length of the lens, and is stored in the memory.

8. The optical disc apparatus according to claim 7, wherein the change of the distance of a recording medium and the lens along the optical axis of the lens depending on a rotational cycle of the motor is extracted at two or more positions in a direction crossing a track or a record mark string of a recording medium.

9. A method of controlling a focus servo for condensing a laser beam in a on-focus state on a recording layer of an optical disc rotated at a predetermined speed by using a condenser lens, comprising:
moving a condenser lens at a constant speed from an initial position to a recording layer of an optical disc, for a focus servo to move a condenser lens along an optical axis, to make the distance between a condenser lens and a recording layer of an optical disc coincide with a focal length of a condenser lens;
keeping an on-focus state by superimposing a wobble component of an optical disc depending on rotation of an optical disc, after pull-in of a focus servo is completed;
storing a control signal corresponding to a wobble component in an on-focus state; and
superimposing a control signal corresponding to the stored wobble component on a control signal for moving a condenser lens, when moving a condenser lens to a recording layer of an optical disc at a constant speed for pulling in again a focus servo, when a focus servo goes off by a disturbance light during the focus servo, or by turning off of a laser beam for shifting to a standby mode.
